(19) United States
(12) Patent Application Publication
(10) Pub. No.: US 2026/0073941 A1
(43) Pub. Date: Mar. 12, 2026

(54) MAGNETIC DISK APPARATUS

(71) Applicants: Kabushiki Kaisha Toshiba, Tokyo (JP); Toshiba Electronic Devices & Storage Corporation, Tokyo (JP)

(72) Inventor: Takahiro KOYANAGI, Yokohama Kanagawa (JP)

(21) Appl. No.: 19/189,661

(22) Filed: Apr. 25, 2025

(30) Foreign Application Priority Data
Sep. 11, 2024 (JP) 2024-157697

(51) Int. Cl. G11B 5/596; G11B 5/012

(52) U.S. Cl. CPC G11B 5/59688; G11B 5/012

(57) ABSTRACT

According to an embodiment, a magnetic disk apparatus includes a magnetic head and a magnetic disk. On the magnetic disk, servo regions are arranged in a circumferential direction at even intervals. Each of the servo regions is a region in which servo data including data pieces is written. A recording frequency of the servo data is different between continuous first radial positions on the magnetic disk. A first data piece among the data pieces is written in each of the servo regions at a first circumferential position where movement times of the magnetic head in the circumferential direction are aligned among the first radial positions. The movement times are based on timing when the magnetic head passes over a reference position on a circumference of the magnetic disk.

### CROSS-REFERENCE TO RELATED APPLICATIONS

This application is based upon and claims the benefit of priority from Japanese Patent Application No. 2024-157697, filed on September 11, 2024; the entire contents of which are incorporated herein by reference.

### FIELD

Embodiments described herein relate generally to a magnetic disk apparatus.

### BACKGROUND

In a related art, servo data is written at a constant recording frequency regardless of a position in the radial direction of a magnetic disk, or is written at a constant recording frequency in each of ranges obtained by dividing the magnetic disk in the radial direction. In contrast, in recent years, a CDS (Constant Density Servo) scheme has been developed as a servo data recording scheme. According to the CDS scheme, a recording frequency is gently changed with respect to the radial direction such that a recording frequency is higher on the outer diameter side than on the inner diameter side. Accordingly, as compared with the servo data recording scheme of the related art, the area of a region where the servo data is written is reduced and the area of a region where user data can be written increases.

However, from the viewpoint of servo control, there is room for improvement in the CDS scheme.

### BRIEF DESCRIPTION OF THE DRAWINGS

FIG. 1 is a diagram illustrating an example of a configuration of a magnetic disk apparatus according to a first embodiment;

FIG. 2 is a diagram illustrating an example of a configuration of the magnetic disk according to the first embodiment;

FIG. 3 is a diagram illustrating an example of a configuration of servo data according to the first embodiment;

FIG. 4 is a diagram illustrating an example of a reference position set in the magnetic disk according to the first embodiment;

FIG. 5 is a diagram illustrating an example of a relationship between a radial position and a recording frequency of servo data according to the first embodiment;

FIG. 6 is a diagram for describing a servo data writing method according to the first embodiment;

FIG. 7 is a diagram for describing an example of a servo data writing method according to a second embodiment;

FIG. 8 is a diagram for describing an example of a burst pattern writing method according to a third embodiment;

FIG. 9 is a diagram for describing another example of the burst pattern writing method according to the third embodiment;

FIG. 10 is a diagram for describing still another example of the burst pattern writing method according to the third embodiment;

FIG. 11 is a diagram for describing an example of a servo data writing method according to a fourth embodiment;

FIG. 12 is a diagram illustrating an example of a shape of a servo region according to a fifth embodiment;

FIG. 13 is a diagram for describing an example of a servo data writing method according to the fifth embodiment;

FIG. 14 is a diagram for describing another example of the servo data writing method according to the fifth embodiment;

FIG. 15 is a diagram for describing still another example of the servo data writing method according to the fifth embodiment;

FIG. 16 is a diagram for describing still another example of the servo data writing method according to the fifth embodiment;

FIG. 17 is a diagram for describing an example of a servo data writing method according to a sixth embodiment;

FIG. 18 is a flowchart illustrating an example of a sync search operation according to the sixth embodiment;

FIG. 19 is a diagram for describing an example of length in the radial direction of a constant frequency region according to the sixth embodiment;

FIG. 20 is a diagram for describing another example of a servo data writing method according to the sixth embodiment; and

FIG. 21 is a diagram for describing write timing for servo data according to a comparative example.

### DETAILED DESCRIPTION

According to embodiments described herein, a magnetic disk apparatus includes a magnetic head and a magnetic disk. On the magnetic disk, servo regions are arranged in a circumferential direction at even intervals. Each of the servo regions is a region in which servo data including data pieces is written. A recording frequency of the servo data is different between continuous first radial positions on the magnetic disk. A first data piece among the data pieces is written in each of the servo regions at a first circumferential position where movement times of the magnetic head in the circumferential direction are aligned among the first radial positions. The movement times are based on timing when the magnetic head passes over a reference position on a circumference of the magnetic disk.

Magnetic disk apparatuses according to embodiments will be described in detail below with reference to the accompanying drawings. Note that the present invention is not limited by these embodiments.

### First Embodiment

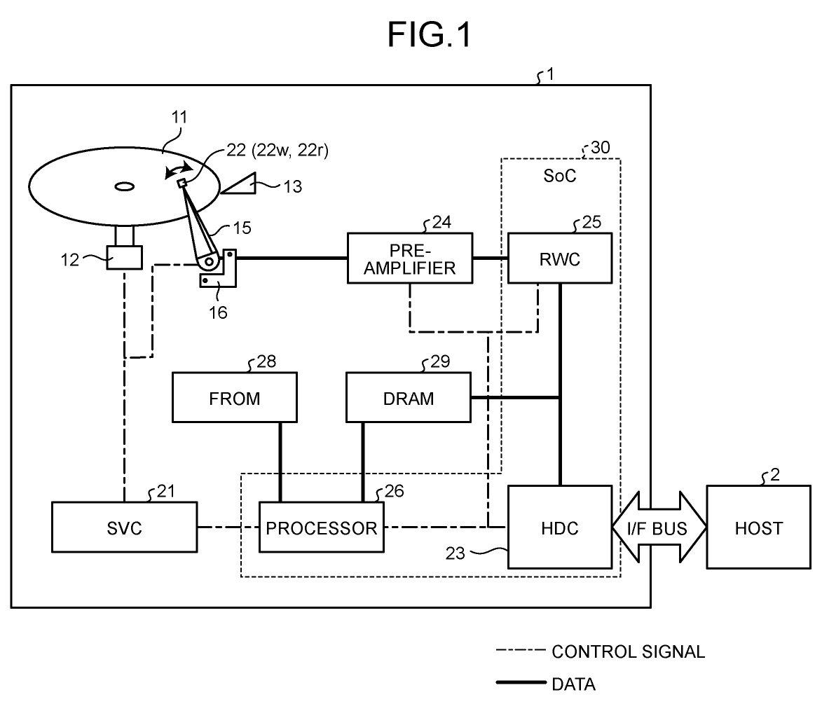

FIG. 1 is a diagram illustrating an example of a configuration of a magnetic disk apparatus 1 according to a first embodiment.

The magnetic disk apparatus 1 is connected to a host 2. The magnetic disk apparatus 1 can receive an access command such as a write command or a read command from the host 2.

The magnetic disk apparatus 1 includes a magnetic disk 11 having a magnetic layer formed on the surface thereof. The magnetic disk apparatus 1 accesses the magnetic disk 11 in response to the access command. The access includes data write and data read.

The data write and read are performed by using a magnetic head 22. The magnetic disk apparatus 1 includes, in addition to the magnetic disk 11, a spindle motor (SPM) 12, a lamp 13, an actuator arm 15, a voice coil motor (VCM) 16, a servo controller (SVC) 21, a magnetic head 22, a hard disk controller (HDC) 23, a preamplifier 24, a read/write channel (RWC) 25, a processor 26, a FROM (Flash Read Only Memory) 28, and a DRAM (Dynamic Random Access Memory) 29.

The magnetic disk 11 is rotated at predetermined rotation speed by the SPM 12 that is attached coaxially to the magnetic disk 11.

The SVC 21 is an integrated circuit having a function of a driver that drives the SPM 12 and the VCM 16. The processor 26 controls the rotation of the SPM 12 and the rotation of the VCM 16 via the SVC 21.

The magnetic head 22 includes a write head 22w and a read head 22r. The magnetic head 22 writes data in the magnetic disk 11 with the write head 22w. The magnetic head 22 reads data from the magnetic disk 11 with the read head 22r. The magnetic head 22 is attached to the distal end of the actuator arm 15. The magnetic head 22 is moved in the radial direction of the magnetic disk 11 by the VCM 16 driven by the SVC 21. Note that one or both of the write head 22w and the read head 22r included in the magnetic head 22 may be respectively provided in plurality for a single magnetic head 22.

When, for example, the rotation of the magnetic disk 11 is stopped, the magnetic head 22 is moved onto the lamp 13. The lamp 13 holds the magnetic head 22 at a position separated from the magnetic disk 11.

The preamplifier 24 is an integrated circuit that writes and reads data via the magnetic head 22. The preamplifier 24 amplifies and outputs a signal read from the magnetic disk 11 by the magnetic head 22 at the time of a read operation and supplies the signal to the RWC 25. The preamplifier 24 amplifies a signal corresponding to write target data supplied from the RWC 25 and supplies the signal to the magnetic head 22 at the time of the write operation.

The DRAM 29 is used as a buffer for data to be transferred to and from the host 2. The DRAM 29 can be used for temporarily storing write target data or data read from the magnetic disk 11.

The DRAM 29 is used as a memory for operation by the processor 26. The DRAM 29 is used as a region to which a firmware program is loaded and a region in which various types of management data are temporarily stored.

The HDC 23 executes control of data transfer performed with the host 2 via an I/F bus. The HDC 23 supplies write target data received from the host 2 to the RWC 25 via the DRAM 29. The HDC 23 receives, via the DRAM 29, read data output from the RWC 25 and transmits the read data to the host 2.

The RWC 25 modulates the write target data supplied from the HDC 23 and supplies the modulated data to the preamplifier 24. The RWC 25 executes demodulation including error correction on a signal read from the magnetic disk 11 and supplied from the preamplifier 24 and thereafter outputs the signal to the HDC 23 as digital data.

The processor 26 is, for example, a CPU (Central Processing Unit). The FROM 28 and the DRAM 29 are connected to the processor 26.

The FROM 28 stores a firmware program, various setting information, and the like. Note that the firmware program may be stored in the magnetic disk 11.

The processor 26 performs overall control of the magnetic disk apparatus 1 in accordance with a firmware program stored in the FROM 28 or the magnetic disk 11. The processor 26 loads a firmware program from the FROM 28 or the magnetic disk 11 to the DRAM 29 and executes control of the SVC 21, the preamplifier 24, the RWC 25, the HDC 23, and the like in accordance with the firmware program loaded to the DRAM 29.

Some of or all the functions of the processor 26 may be implemented by a hardware circuit such as an FPGA (Field-Programmable Gate Array) or an ASIC (Application Specific Integrated Circuit).

The HDC 23, the RWC 25, and the processor 26 are configured as an SoC (System-On-a-Chip) 30 , namely, one integrated circuit. Besides the above, the SoC 30 may include other elements (for example, the FROM 28 or the DRAM 29).

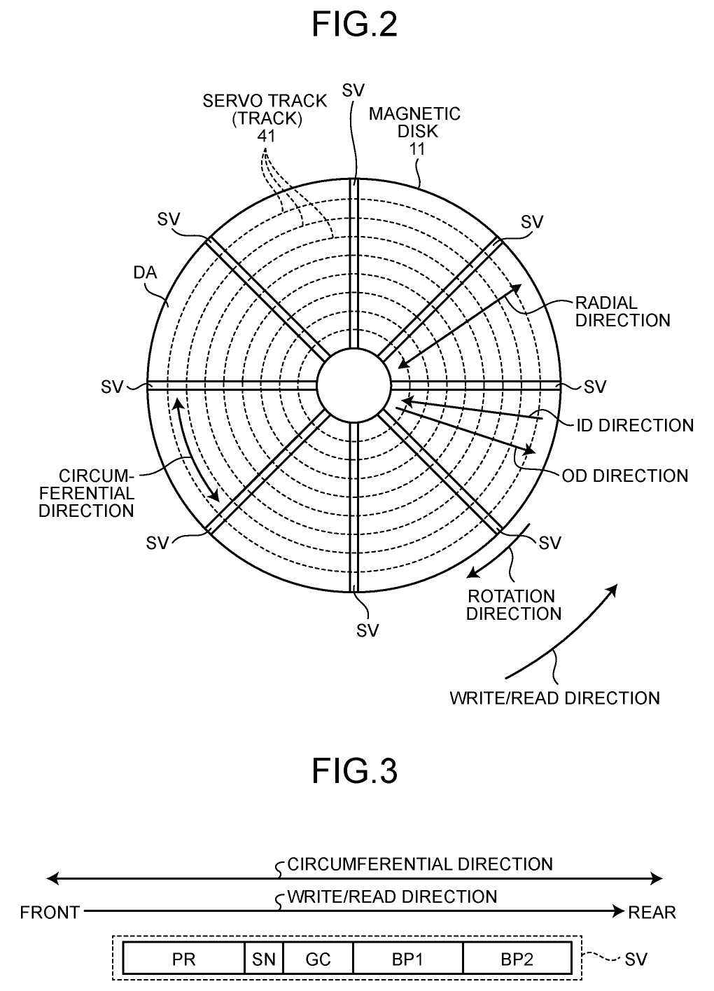

FIG. 2 is a diagram illustrating an example of a configuration of the magnetic disk 11 according to the first embodiment. Note that an example of a rotation direction of the magnetic disk 11 is illustrated in this figure. The magnetic head 22 moves relatively to the magnetic disk 11 in accordance with the rotation of the magnetic disk 11. Therefore, a write/read direction, namely, a direction in which data is written or read by the magnetic head 22 in the circumferential direction is opposite to the rotation direction of the magnetic disk 11.

In the radial direction, a direction from the edge to the center of the magnetic disk 11 is an ID direction and a direction from the center to the edge of the magnetic disk 11 is an OD direction.

Servo data used for positioning the magnetic head 22 is written in the magnetic disk 11 by, for example, a servo writer or self-servo write (SSW) in a manufacturing process. According to FIG. 2, servo regions SV arranged radially in the radial direction and at even intervals in the circumferential direction are provided as an example of arrangement of servo regions in which servo data is written. A region between two servo regions SV continuous in the circumferential direction is used as a data region DA where data is written.

Concentric servo tracks 41 are provided on the magnetic disk 11 in the radial direction. Each of concentric data tracks are provided in an upper region of the magnetic disk 11 where each of the concentric servo tracks 41 is provided. Data sectors that are continuous in the circumferential direction are provided in regions segmented by the data region DA on the data tracks. Data can be written in the data sectors. Data that can be written in the data sectors includes user data received from the host 2, metadata (for example, an error correction code) incidental to the user data, and system data. The magnetic disk apparatus 1 holds, in advance, setting of a positional relationship between the plurality of servo tracks 41 and the plurality of data tracks, and performs positioning control for positioning the magnetic head 22 on a target data track based on servo data written in the servo regions SV. The positioning control includes a seek operation that is an operation of moving the magnetic head 22 in the radial direction toward a target data track and a tracking operation of maintaining the magnetic head 22 on the target data track.

Note that the servo tracks 41 may be used as data tracks. In the following description, for simplification of description, it is assumed that the servo tracks 41 are used as data tracks. The servo track 41 is simply described as track 41. Individual regions into which the servo regions SV are divided by the tracks 41 are also referred to as servo sectors.

A position in the radial direction is defined as a radial position. A position in the circumferential direction is defined as a circumferential position.

FIG. 3 is a diagram illustrating an example of a configuration of servo data according to the first embodiment.

Here, an expression of a positional relationship is defined. In a case where there are a first region and a second region adjacent to each other in a write/read direction and the magnetic head 22 passes over the first region immediately before passing the second region, the second region is expressed as a “rear” region of the first region and the first region is expressed as a “front” region of the second region. In the circumferential direction, a position where the magnetic head 22 initially passes over in a certain region is sometimes described as a “head” of the region. In data written in a certain region, a head portion of this region is sometimes described as “head” of the data.

As illustrated in FIG. 3, the servo data includes plural types of servo data pieces. The types of servo data pieces are a preamble PR, a sync mark SN, a gray code GC, a burst pattern BP1, and a burst pattern BP2. In the servo region SV, the preamble PR, the sync mark SN, the gray code GC, the burst pattern BP1, and the burst pattern BP2 are arranged in this order in the write/read direction.

The preamble PR is pattern data of a single period that periodically changes in the circumferential direction. A frequency of the pattern data of the preamble PR corresponds to a recording frequency of servo data. The preamble PR is used for adjusting amplitude, a phase, and a frequency of sampling data when a servo waveform read by the read head 22r is captured into the RWC 25 as the sampling data based on a servo clock. The servo clock is generated by the RWC 25. Thus, the preamble PR is used for matching the servo clock with a recording frequency of the servo data.

The sync mark SN is pattern data used for determining read timing for the servo data. The SoC 30 determines read timings for various servo data pieces based on detection timing for the sync mark SN and a count value of a not-illustrated counter included in the SoC 30.

The gray code GC includes cylinder addresses for identifying tracks 41 provided in the magnetic disk 11 and sector addresses for identifying servo sectors on the tracks 41.

The burst pattern BP1 and the burst pattern BP2 are pattern data used for detecting an offset amount of the position of the magnetic head 22 from the track center of a certain servo track 41 (more precisely, the track 41 indicated by a cylinder address).

The burst patterns are captured into the RWC 25 at a sampling interval based on the servo clock. The RWC 25 performs, for example, discrete Fourier transform (DFT) processing on waveforms of the captured burst patterns to thereby acquire a phase and an amplitude. The SoC 30 calculates an offset amount of the magnetic head 22 from the track center of the track 41 based on the phase and the amplitude acquired by the RWC 25. The SoC 30 (for example, the processor 26) estimates a radial position of the magnetic head 22 based on the cylinder address obtained from the gray code GC and the offset amount obtained from the burst patterns.

Note that the servo data can include any type of a servo data piece other than these. In one example, the servo data may include a post code indicating a correction amount of positional deviation based on RRO (Repeatable Runout).

In the magnetic disk 11, a reference position is set at one point on the circumference. Numerical information in ascending order based on a reference position is given, as a sector address, to servo sectors arranged at even intervals in the circumferential direction.

Note that the servo sectors are regions into which the servo region SV is divided by the track 41. Thus, servo addresses of servo sectors included in one servo region SV are common. In the following description, the servo region SV including a servo sector having a sector address i is sometimes described as servo region SV#i.

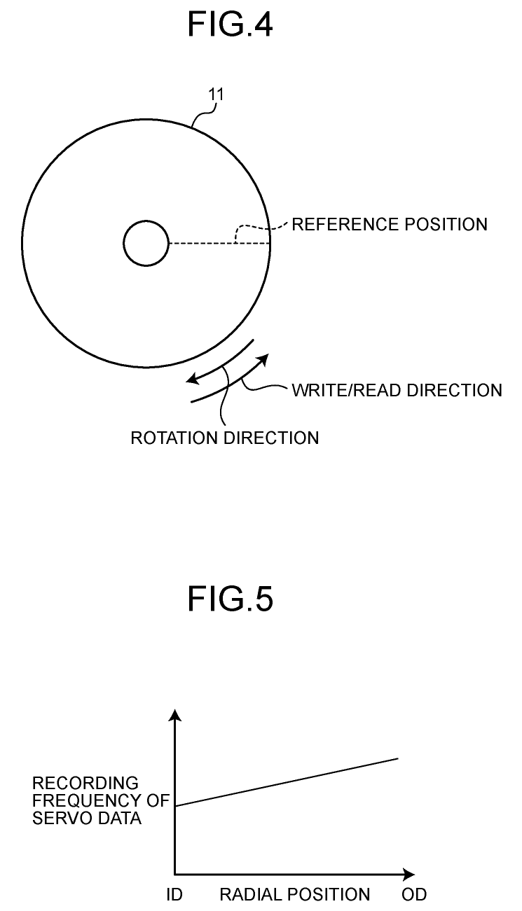

FIG. 4 is a diagram illustrating an example of a reference position set in the magnetic disk 11 according to the first embodiment.

In the example illustrated in FIG. 4, a line of a reference position extending straight in the radial direction is provided. Note that the shape of the line of the reference position does not always have to be a straight line. In one example, the line of the reference position may have a curved shape in accordance with a path on which the magnetic head 22 is moved by the VCM 16.

In the first embodiment, the servo data is recorded by a CDS scheme. According to the CDS scheme, as illustrated in FIG. 5, a recording frequency is gently changed with respect to the radial direction such that a recording frequency of the servo data is higher on the outer circumference side than on the inner circumference side.

As described above, the magnetic disk 11 is rotated at the constant rotation speed. Thus, relative movement speed of the magnetic head 22 in the circumferential direction with respect to the magnetic disk 11 increases toward the outer circumference. Thus, when a recording frequency is constant in the radial direction, the length in the circumferential direction of the servo sector is longer toward the outer circumference.

In contrast, according to the ODS scheme, since recording density of servo data is higher on the outer circumference side than on the inner circumference side, it is possible to prevent the length in the circumferential direction of the servo sector from increasing toward the outer circumference. Accordingly, for example, as illustrated in FIG. 2, the width in the circumferential direction of the servo regions SV can be constant regardless of a radial position. Thus, as compared with a case where the recording frequency is constant in the radial direction, a region where the user data can be recorded, namely, the area of the data region DA increases.

Note that, in the example illustrated in FIG. 2, the servo regions SV have a shape extending straight from the inner circumference to the outer circumference. The shape of the servo regions SV is not limited to this. The servo regions SV may have a curved shape.

A technique compared with the embodiment will be described. The technique compared with the embodiment is referred as a comparative example. According to the comparative example, servo data is written by an ODS scheme. Write timing for the servo data is determined by counting using a servo clock (or a frequency-divided clock thereof) adjusted to a frequency corresponding to a recording frequency. The servo data is recorded at timing when a count value of the servo clock (or the frequency-divided clock thereof) reaches a common value regardless of a radial position. Accordingly, the servo regions SV extending in the radial direction are formed.

FIG. 21 is a diagram for describing write timing for servo data according to a comparative example. In the figure, the vertical axis represents a radial position. The horizontal axis represents a time axis. In the present specification, the time axis represents elapse of time after a magnetic head passes over a reference position. Note that, in FIG. 21, write timings of servo data in a certain servo region SV at three radial positions are illustrated.

In the comparative example, the ODS scheme is used. Thus, as illustrated in FIG. 21, the length of the servo region SV on the time axis is shorter toward the outer circumference.

Moreover, in the comparative example, for one servo region SV, servo data is written at timing when the count value of the servo clock (or the frequency-divided clock) reaches the common value regardless of the radial position. Since the frequency of the servo clock is higher toward the outer circumference, as illustrated in FIG. 21, recording timing for the servo data is earlier toward the outer circumference.

Read of the servo data is controlled by a servo gate signal. The servo gate signal is a signal indicating whether the read of the servo data is permitted. A state in which the servo gate signal is opened is a state in which the read of the servo data is permitted. A state in which the servo gate signal is not opened is a state in which the read of the servo data is not permitted.

When the magnetic head is moving toward the next region after passing over a certain servo region SV, the SoC determines timing for opening the servo gate signal for reading servo data of the next servo region SV based on time when the sync mark SN is detected in the servo region SV over which the magnetic head has passed.

In the comparative example illustrated in FIG. 21, a position on the time axis where the servo data is written is different for each radial position. Thus, when moving the magnetic head in the radial direction, the SoC needs to determine timing for opening the servo gate signal considering both of a radial position at the time when the magnetic head passes over the certain servo region SV and a radial position at the time when the magnetic head reaches the next servo region SV. Thus, in the comparative example, calculation required to determine the timing for opening the servo gate signal is complicated.

In contrast, according to the first embodiment, a write position of the servo data is devised in order to facilitate determination of the timing for opening the servo gate signal.

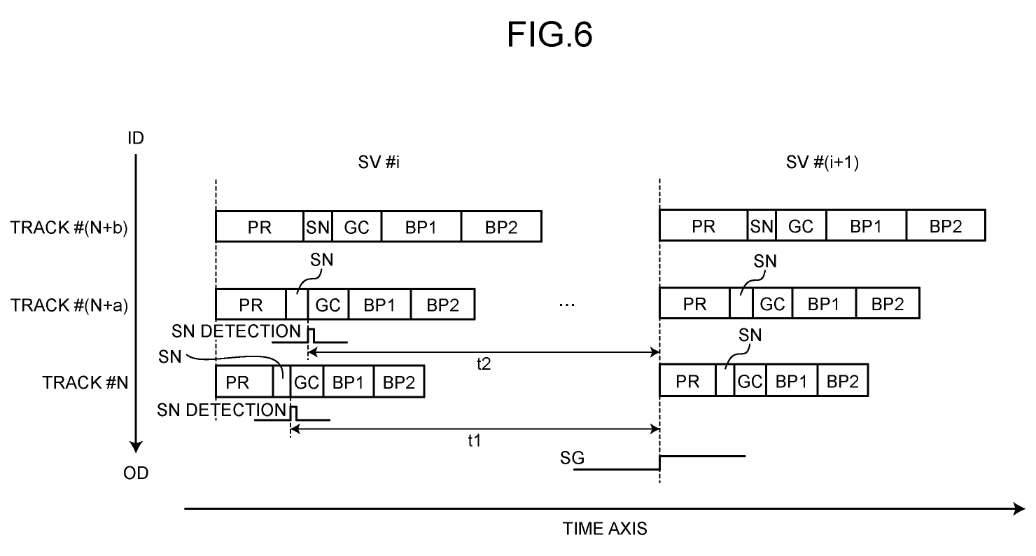

FIG. 6 is a diagram for describing a servo data writing method according to the first embodiment. In the figure, the vertical axis represents a radial position. The horizontal axis represents a time axis. Note that the time axis represents elapse of time after the magnetic head 22 passes over the reference position. Thus, the time axis can be considered a movement time of the magnetic head 22 in the circumferential direction based on timing when the magnetic head 22 passes over the reference position. The movement time is a time in which the magnetic head 22 moves relatively to the magnetic disk 11. In the following description, the movement time of the magnetic head 22 in the circumferential direction based on the timing when the magnetic head 22 passes over the reference position is sometimes abbreviated as temporal position.

In FIG. 6, write timings for servo data relating to a servo region SV#i and the servo region SV#(i+1) at three radial positions are illustrated. The three radial positions are a radial position of a track #N, a radial position of a track #(N+a), and a radial position of a track #(N+b) in order from one closer to the outer circumference.

In the first embodiment, in the same servo region SV, temporal positions where the preambles PR are written are aligned among all the radial positions. In other words, the preamble PR is written at a circumferential position where movement times of the magnetic head 22 in the circumferential direction based on the timing when the magnetic head 22 passes over the reference position on the circumference are aligned among all the radial positions. Thus, as illustrated in FIG. 6, temporal positions where the preambles PR are written are aligned for each of the radial position of the track #N, the radial position of the track #(N+a), and the radial position of the track #(N+b).

Since the write of the servo data is performed as described above, calculation required for determining timing for opening the servo gate signal is facilitated compared with the comparative example.

In one example, a case where the magnetic head 22 moves along the track #N and passes over the servo region SV#i is considered. In such a case, by opening a servo gate signal SG when a time t1 has elapsed after the sync mark SN is detected in the servo region SV#i, the SoC 30 is able to read the servo data written in the servo region SV#(i+1) from the head regardless of the track 41 of a moving destination of the magnetic head 22.

In another example, a case where the magnetic head 22 moves along the track #(N+a) and passes over the servo region SV#i is considered. In such a case, by opening the servo gate signal SG when a time t2 has elapsed after the sync mark SN is detected in the servo region SV#i, the SoC 30 is able to read the servo data written in the servo region SV#(i+1) from the head regardless of the track 41 of the moving destination of the magnetic head 22.

Therefore, regardless of the radial position of the moving destination, the SoC 30 can determines the timing for opening the servo gate signal based on the radial position where the sync mark SN is detected. Thus, the calculation required for determining the timing for opening the servo gate signal SG is facilitated compared with the comparative example.

### Second Embodiment

When rotation speed of the magnetic disk 11 fluctuates, an interval of a detection time for the sync mark SN fluctuates. The SoC 30 sometimes has a function of, when the detection time for the sync mark SN deviates from an ideal detection time, correcting a frequency of a servo clock based on a deviation amount of the detection time for the sync mark SN. This function is referred to as rotational fluctuation following function. The ideal detection time is a detection time for the sync mark SN in the case where the magnetic disk 11 is rotating at set rotation speed. According to the rotational fluctuation following function, a frequency of the servo clock can be caused to follow rotational fluctuation of the magnetic disk 11.

According to the comparative example, the detection time for the sync mark SN varies depending on a radial position. Thus, even if the rotation speed of the magnetic disk is not fluctuating, while the magnetic head is moving in the radial direction, the interval of the detection time for the sync mark SN fluctuates with the movement of the magnetic head in the radial direction. Therefore, when the rotational fluctuation following function described above is implemented, it is assumed that, even if the rotation speed of the magnetic disk does not fluctuate, unintended correction of the servo clock is performed and servo control is hindered. For example, it is difficult to open the servo gate signal at correct timing.

In a second embodiment, a write position of the servo data is devised such that the interval of the detection time for the sync mark SN does not change regardless of a radial position if the rotation speed of the magnetic disk 11 does not fluctuate.

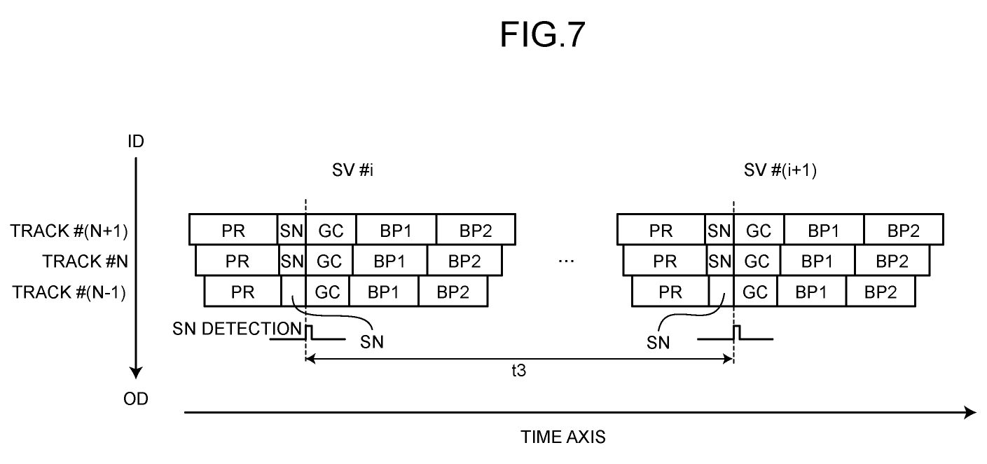

FIG. 7 is a diagram for describing an example of a servo data writing method according to a second embodiment. In the figure, the vertical axis represents a radial position. The horizontal axis represents a time axis.

As illustrated in FIG. 7, in the same servo region SV, temporal positions where the sync marks SN are written are aligned among all radial positions. With this configuration, the interval of the detection time for the sync mark SN is constant at time t3 regardless of a radial position in design. Therefore, even while the magnetic head 22 is moving in the radial direction, the sync mark SN is detected at intervals of the time t3 as long as the rotation speed of the magnetic disk 11 does not fluctuate. On the other hand, when the rotation speed of the magnetic disk 11 fluctuates, the interval of the detection time for the sync mark SN deviates from the time t3.

As described above, even when the rotational fluctuation following function is implemented, it is possible to prevent unintended correction of the servo clock from being performed.

### Third Embodiment

According to the comparative example, a temporal position corresponding to a circumferential position where a burst pattern (burst patterns BP1 and BP2) is written is different depending on a radial position. Thus, regular timing for demodulating the burst pattern deviates between two adjacent tracks. Thus, when the magnetic head is present at a position across a boundary between the two tracks, a phase error occurs in a demodulation result of the burst pattern because of a shift of the regular timing for demodulating the burst pattern. When a phase burst is applied as a burst pattern, this phase error causes deterioration in positioning control accuracy.

In a third embodiment, a write position of the burst pattern is devised such that an error in control of a burst gate and the phase error of the demodulation result of the burst pattern can be suppressed.

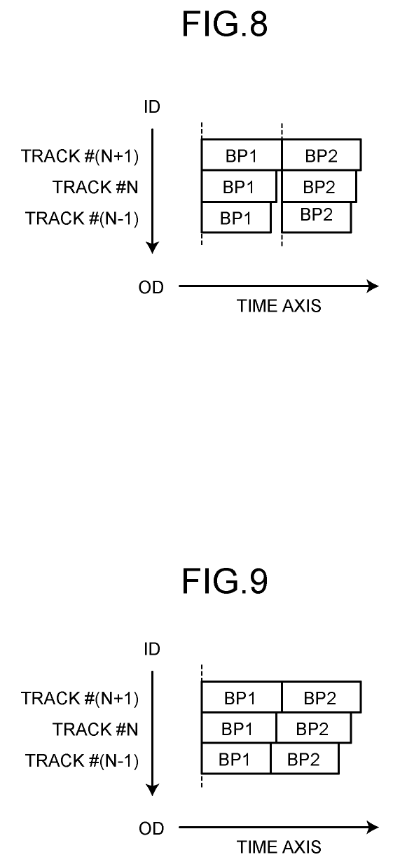

FIG. 8 is a diagram for describing an example of a burst pattern writing method according to a third embodiment. In the figure, the vertical axis represents a radial position. The horizontal axis represents a time axis.

As illustrated in FIG. 8, temporal positions where the burst patterns BP1 and the burst patterns BP2 are written are each aligned among all radial positions. Thus, a shift of regular timing for demodulating the burst pattern is greatly suppressed. As a result, deterioration in the positioning control accuracy can be greatly suppressed.

Note that, depending on the specifications of the SoC 30, it is sometimes difficult to adjust write timing for the burst pattern with a fine step width. In such a case, for example, as illustrated in FIG. 9, only for a head burst pattern of the burst pattern BP1 and the burst pattern BP2, namely, the burst pattern BP1, temporal positions where the head burst patterns are written may be aligned among all the radial positions. The shift of the regular timing for demodulating the burst pattern is suppressed. As a result, deterioration in the positioning control accuracy can be suppressed.

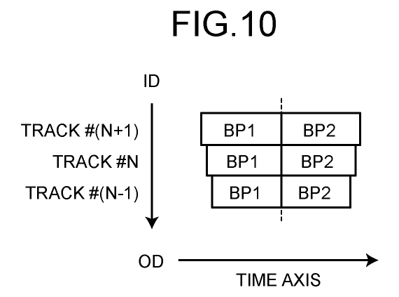

Note that, when the temporal positions where only the head burst patterns are written are aligned among the radial positions, it is likely that, for a burst pattern farther from the head burst pattern in the circumferential direction, the shift of the regular timing for demodulating the burst pattern increases and, as a result, deterioration in the positioning control accuracy cannot be suppressed much. Thus, as illustrated in FIG. 10, only for a burst pattern other than the head burst pattern among the burst pattern BP1 and the burst pattern BP2, namely, the burst pattern BP2, temporal positions where the burst patterns are written may be aligned among all the radial positions.

### Fourth Embodiment

The preamble PR in the first embodiment, the sync mark SN in the second embodiment, and the burst pattern in the third embodiment are written, at the radial position, at circumferential positions where the temporal positions are aligned among all the radial positions. Each of any two types of the preamble PR, the sync mark SN, and the burst pattern may be written at circumferential positions where temporal positions are aligned among all the radial positions.

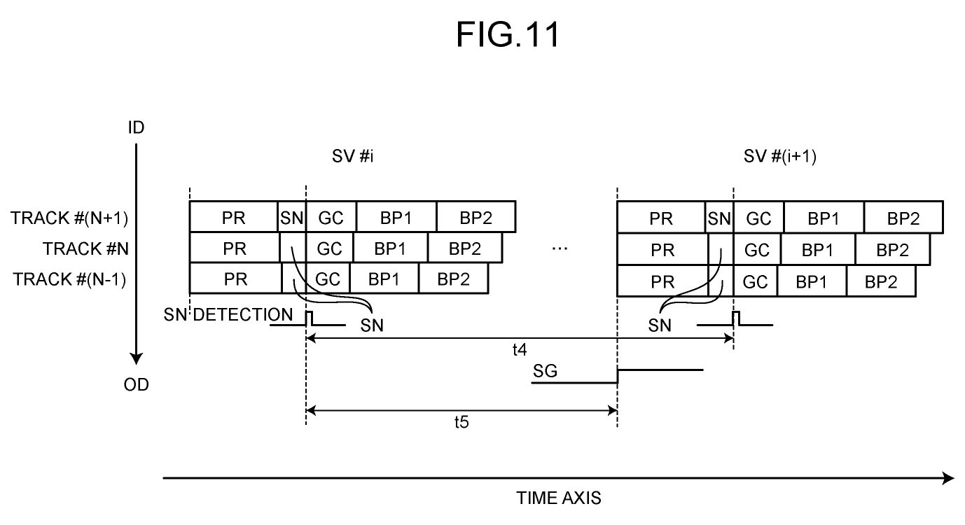

FIG. 11 is a diagram for describing an example of a servo data writing method according to a fourth embodiment. In the figure, the vertical axis represents a radial position. The horizontal axis represents a time axis.

In the example illustrated in FIG. 11, in the same servo region SV, temporal positions where the preambles PR are written are aligned among all the radial positions and temporal positions where the sync marks SN are written are aligned among all the radial positions.

With this configuration, by opening the servo gate signal SG when the time t5 has elapsed after the sync mark SN is detected, the SoC 30 can read servo data written in the next servo region SV from the head regardless of not only a radial position of the magnetic head 22 but also a radial position where the sync mark SN is detected. Thus, the calculation required to determine timing for opening the servo gate signal SG is facilitated.

Moreover, as in the second embodiment, an interval of a detection time for the sync mark SN is constant (here, constant at time t4) regardless of a radial position in design. Thus, even when the rotational fluctuation following function is implemented, it is possible to prevent unintended correction of the servo clock from being performed.

Note that, since the temporal positions where the preambles PR are written are aligned among all the radial positions and the temporal positions where the sync marks SN are written are aligned among all the radial positions, the number of waveforms of one cycle included in the preamble PR can be different depending on a radial position. Specifically, the number of waveforms of one cycle included in the preamble PR increases toward the outer circumference.

### Fifth Embodiment

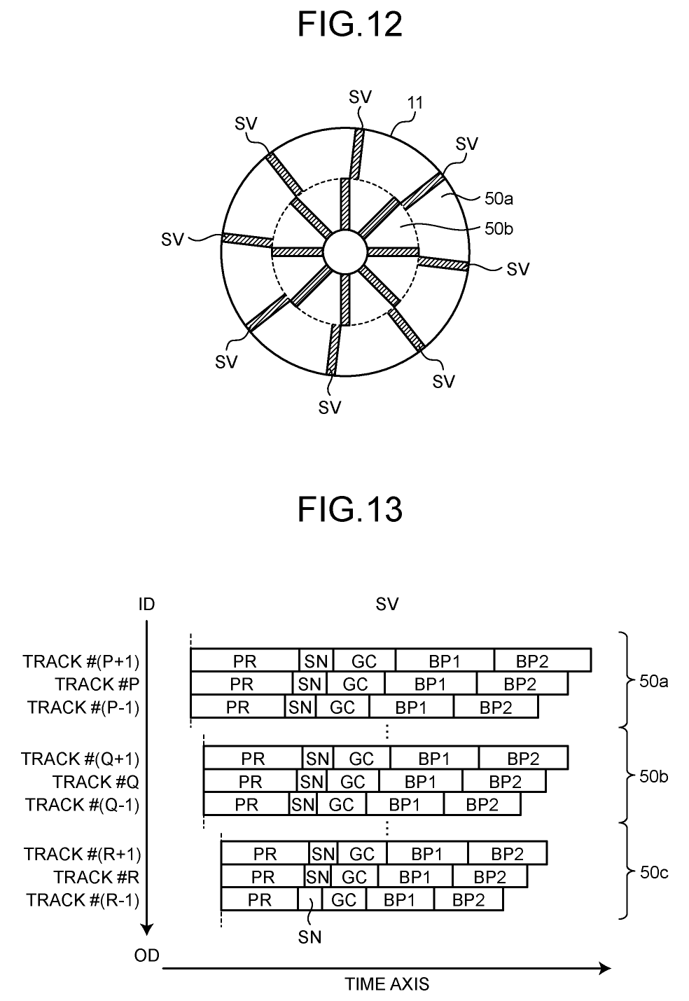

FIG. 12 is a diagram illustrating an example of a shape of the servo region SV according to a fifth embodiment. In the example illustrated in the figure, a recording surface of the magnetic disk 11 is divided into two regions 50a and 50b arranged side by side in the radial direction. In each of the two regions 50a and 50b, the servo regions SV extend straight from the inner circumference side to the outer circumference side. However, at a boundary between the region 50a and the region 50b, the servo regions SV are discontinuous.

Such a phenomenon can occur when, for example, servo data is written by the SSW. In the SSW, the SoC 30 writes the servo data from the inner circumference to a certain radial position and writes the servo data from the outer circumference to the radial position. Accordingly, the recording surface of the magnetic disk 11 is divided into two regions 50a and 50b at the radial position.

Note that a write direction of the servo data for each of the regions 50a and 50b is not limited to this. The recording surface of the magnetic disk 11 may be divided into three or more regions 50 arranged side by side in the radial direction and the servo regions SV may be discontinuous at boundaries of the regions. Reference positions may be discontinuous in accordance with the servo regions SV being discontinuous.

When the recording surface of the magnetic disk 11 is divided into plural regions 50 arranged side by side in the radial direction, all of the first embodiment, the second embodiment, the third embodiment, and the fourth embodiment can be applied to the regions 50.

FIG. 13 is a diagram for describing an example of a servo data writing method according to the fifth embodiment. In the figure, the vertical axis represents a radial position. The horizontal axis represents a time axis.

In FIG. 13, write timings for servo data in the regions 50a, 50b, and 50c, which are an example of the divided regions 50, are illustrated. As continuous radial positions forming the region 50a, a radial position of a track #(P-1), a radial position of a track #P, and a radial position of a track #(P+1) are illustrated in order from one closest to the outer circumference. As continuous radial positions forming the region 50b, a radial position of a track #(Q-1), a radial position of a track #Q, and a radial position of a track #(Q+1) are illustrated in order from one closest to the outer circumference. As continuous radial positions forming the region 50c, a radial position of a track #(R-1), a radial position of a track #R, and a radial position of a track #(R+1) are illustrated in order from one closest to the outer circumference.

In the example illustrated in FIG. 13, servo data is written in each of the regions 50a, 50b, and 50c by the same method as the method in the first embodiment. Thus, temporal positions where the preambles PR are written are aligned among all the radial positions in the region 50a. Temporal positions where the preambles PR are written are aligned among all the radial positions in the region 50b. Temporal positions where the preambles PR are written are aligned among all the radial positions in the region 50c. With this configuration, the same effects as the effects of the first embodiment can be obtained in each of the regions 50a, 50b, and 50c.

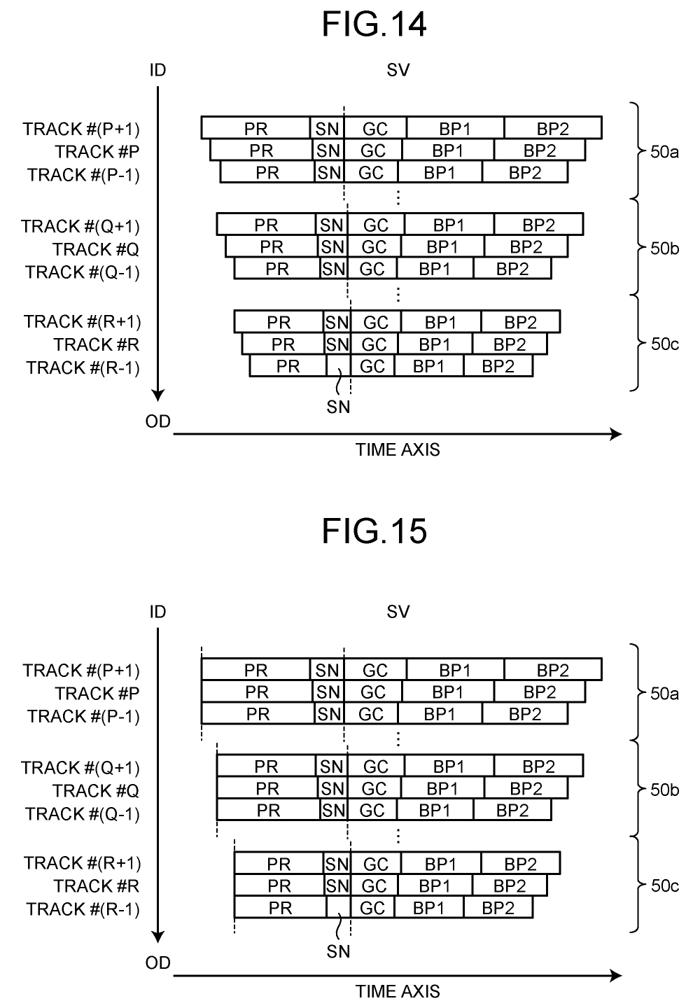

FIG. 14 is a diagram for describing another example of the servo data writing method according to the fifth embodiment. For the example illustrated in FIG. 14, matters different from the matters related to FIG. 13 will be described.

In the example illustrated in FIG. 14, servo data is written in each of the regions 50a, 50b, and 50c by the same method as the method in the second embodiment. Thus, temporal positions where the sync marks SN are written are aligned among all the radial positions in the region 50a. Temporal positions where the sync marks SN are written are aligned among all the radial positions in the region 50b. Temporal positions where the sync marks SN are written are aligned among all the radial positions in the region 50c. With this configuration, the same effects as the effects of the second embodiment can be obtained in each of the regions 50a, 50b, and 50c.

FIG. 15 is a diagram for describing still another example of the servo data writing method according to the fifth embodiment. Note that, in the example illustrated in FIG. 15, matters different from the matters relative to FIG. 13 will be described.

In the example illustrated in FIG. 15, servo data is written in each of the regions 50a, 50b, and 50c by the same method as the method in the fourth embodiment. Thus, temporal positions where the preambles PR are written are aligned among all the radial positions in the region 50a. Temporal positions where the sync marks SN are written are aligned among all the radial positions in the region 50a. Temporal positions where the preambles PR are written are aligned among all the radial positions in the region 50b. Temporal positions where the sync marks SN are written are aligned among all the radial positions in the region 50b. Temporal positions where the preambles PR are written are aligned among all the radial positions in the region 50c. Temporal positions where the sync marks SN are written are aligned among all the radial positions in the region 50c. With this configuration, the same effects as the effects of the fourth embodiment can be obtained in each of the regions 50a, 50b, and 50c.

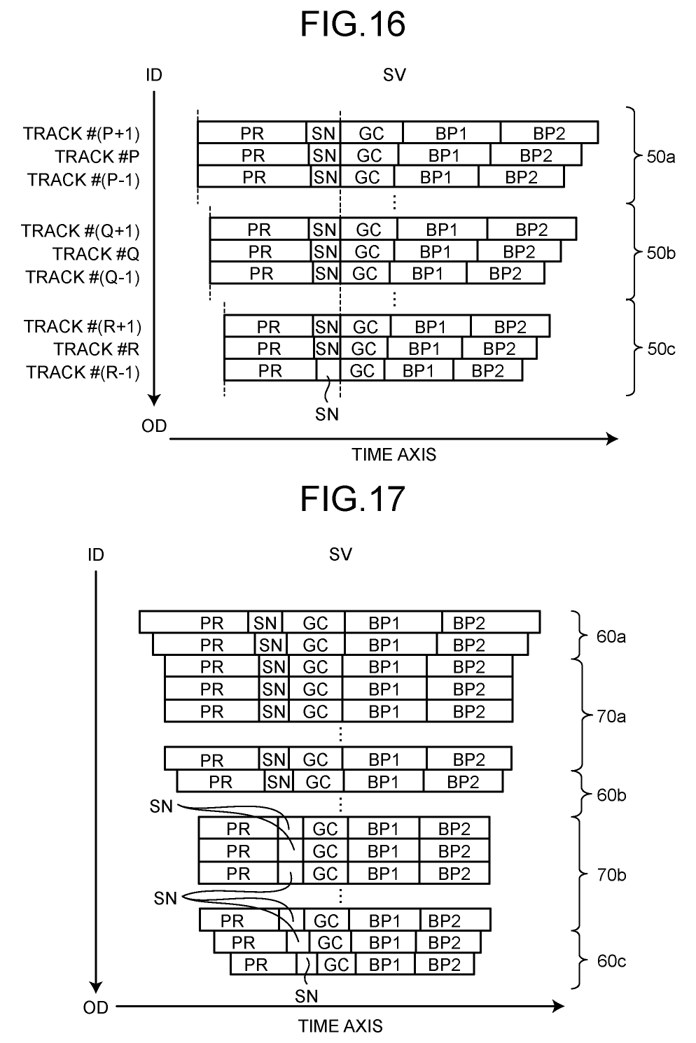

FIG. 16 is a diagram for describing still another example of the servo data writing method according to the fifth embodiment. Note that, in the example illustrated in FIG. 16, matters different from the matters relative to FIG. 13 will be described.

In the example illustrated in FIG. 16, servo data is written in each of the regions 50a, 50b, and 50c by the same method as the method in the fourth embodiment. However, temporal positions where the sync marks SN are written are aligned among all the radial positions in the regions 50a, 50b, and 50c.

With this configuration, an interval of a detection time for the sync mark SN is constant regardless of the radial positions in the regions 50a, 50b, and 50c in design. Therefore, even while the magnetic head 22 is moving in the radial direction in the regions 50a, 50b, and 50c, the sync marks SN can be detected at the same interval as long as the rotation speed of the magnetic disk 11 does not fluctuate.

### Sixth Embodiment

In servo control, when failing in detection of the sync mark SN, the SoC 30 executes a sync search operation of searching for the sync mark SN. When the sync search operation is started, in order to synchronize with a pattern of the preamble PR, the SoC 30 sets, in the RWC 25, a frequency that should be detected.

According to the comparative example, the recording frequency is different depending on the radial position. Therefore, when the sync search operation is started when the magnetic head is moving at high speed in the radial direction, calculation of the frequency set in the RWC is complicated. For example, the SoC predicts a radial position where servo data is read next based on moving speed and a movement time of the magnetic head in the radial direction. Then, the SoC sets a recording frequency at the predicted radial position in the RWC.

However, it is difficult to accurately predict a radial position where servo data is read next. Thus, it is likely that that an appropriate frequency cannot be set in the RWC. When an appropriate frequency cannot be set in the RWC, runaway of seek control can occur.

In contrast, according to the sixth embodiment, the radial direction of the magnetic disk 11 is divided into plural regions and these regions include a region where the recording frequency of the servo data is constant regardless of the radial direction.

FIG. 17 is a diagram for describing an example of a servo data writing method according to a sixth embodiment. In the figure, the vertical axis represents a radial position. The horizontal axis represents a time axis.

In FIG. 17, write timings for servo data in regions 60a, 70a, 60b, 70b, and 60c are illustrated. The region 60a, the region 70a, the region 60b, the region 70b, and the region 60c are arrayed in this order from the inner circumference.

In the regions 60a, 60b, and 60c, a recording frequency is gently changed with respect to the radial direction such that the CDS scheme, namely, the recording frequency of the servo data is higher on the outer circumference side than on the inner circumference side. The first embodiment, the second embodiment, the third embodiment, the fourth embodiment, or the fifth embodiment may be applied or may not be applied to the regions 60a, 60b, and 60c.

In the regions 70a and 70b, the recording frequency of the servo data is constant regardless of a radial position. Thus, each of the regions 70a and 70b, the recording frequency of the servo data is common at a certain value among continuous radial positions. However, in the example illustrated in FIG. 17, the recording frequency of the servo data in the region 70b is higher than the recording frequency of the servo data in the region 70a. Each of the regions 70a and 70b is referred to as constant frequency region.

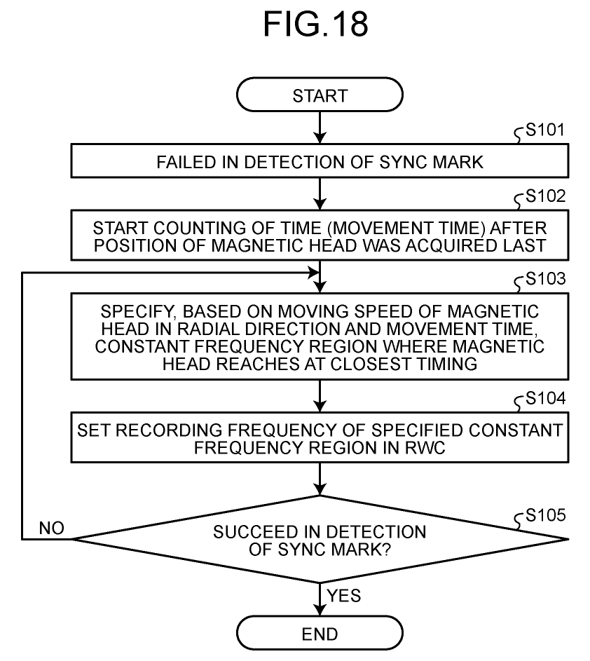

FIG. 18 is a flowchart illustrating an example of a sync search operation according to the sixth embodiment.

When failing in detection of the sync mark SN when the magnetic head 22 passes over a certain servo region SV (S101), the SoC 30 starts a sync search operation. In the sync search operation, the SoC 30 starts counting of a time after the position of the magnetic head 22 is acquired based on servo data (S102). The time counted in S102 is referred to as a movement time as a meaning of a time of movement of the magnetic head 22 in a time after the position of the magnetic head 22 is acquired based on the servo data.

The SoC 30 determines a constant frequency region where the magnetic head 22 arrives at the closest timing based on moving speed in the radial direction of the magnetic head 22 and the movement time (S103).

In one example, when failing in detection of the sync mark SN while the magnetic head 22 is moving in the OD direction in the region 60b and then it is estimated based on the moving speed in the radial direction of the magnetic head 22 and the movement time that the magnetic head 22 reaches the region 70b, the SoC 30 determines that the region 70b is a constant frequency region where the magnetic head 22 reaches at the closest timing.

In one example, when failing in detection of the sync mark SN while the magnetic head 22 is moving in the ID direction in the region 60b and then it is estimated based on the moving speed in the radial direction of the magnetic head 22 and the movement time that the magnetic head 22 reaches the region 70a, the SoC 30 that the region 70a is a constant frequency region where the magnetic head 22 reaches at the closest timing.

The SoC 30 sets a recording frequency of servo data in the determined constant frequency region in the RWC 25 (S104). Accordingly, when the magnetic head 22 passes the servo region SV in the determined constant frequency region, the SoC 30 can synchronize with a pattern of the preamble PR of the servo region SV, and can detect the sync mark SN.

When SoC 30 succeeds in detection of the sync mark (S105: No), the sync search operation ends. When the SoC 30 succeeds in detection of the sync mark (S105: Yes), the control transitions to S103 and the SoC 30 determines another constant frequency region.

As described above, a region 70 where the recording frequency of the servo data is constant regardless of the radial position is provided on each of the inner circumference side and the outer circumference side of the region 60 where the servo data is recorded by the CDS scheme. Thus, in the sync search operation, a frequency that should be detected can be easily and appropriately set.

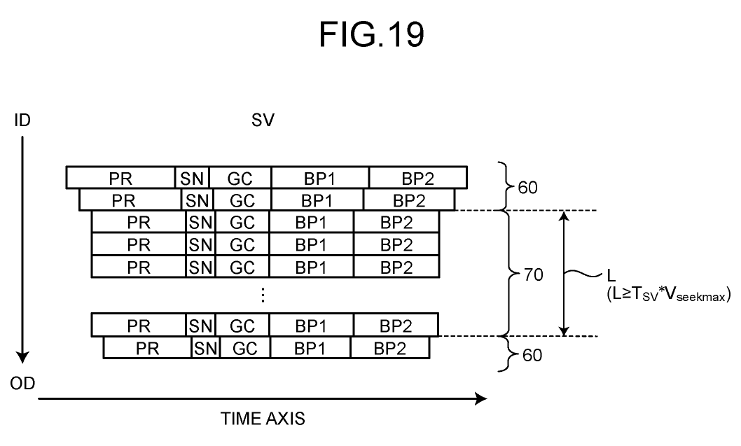

Note that, to enable the magnetic head 22 to securely pass over the constant frequency region determined by the processing of S103, for example, as illustrated in FIG. 19, a radial length L of the regions 70 may be set to satisfy the following Expression (1). Note that T_{SV} is an interval of time in which the magnetic head 22 passes the servo region SV. Vₛₑₑₖₘₐₓ denotes the maximum seek speed, namely, a maximum value of the moving speed of the magnetic head 22 in the radial direction.

L≥T_{SV}*Vₛₑₑₖₘₐₓ ··· (1)

Note that there may be the region 70 to which a relationship of the Expression (1) described above is not applied.

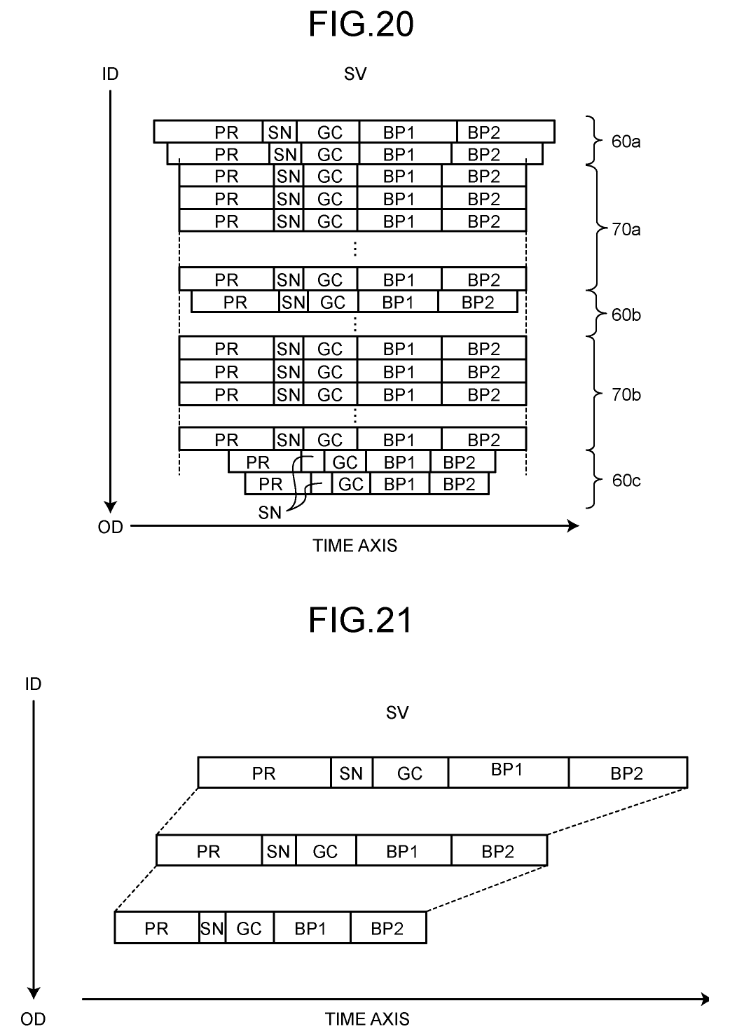

FIG. 20 is a diagram for describing another example of a servo data writing method according to the sixth embodiment. In the figure, the vertical axis represents a radial position. The horizontal axis represents a time axis.

In the example illustrated in FIG. 20, a recording frequency of the servo data in the region 70a is equal to a recording frequency of the servo data in the region 70b. As described above, a common frequency may be applied as the recording frequency of the servo data in two or more regions 70. Accordingly, the processing in S103 illustrated in FIG. 18 can be omitted.

### Conclusion

According to the first to fifth embodiments, in the magnetic disk 11, the recording frequency of the servo data is different at continuous radial positions (described as first radial positions). In the examples described above, the first radial positions are radial positions on the tracks 41 continuous in the radial direction. In each servo region SV, a servo data piece (described as first data piece) of a specific type among servo data is written at circumferential positions (described as first circumferential positions) at the first radial positions where temporal positions, namely, movement times of the magnetic head 22 in the circumferential direction based on timing when the magnetic head 22 passes over a reference position on the circumference are aligned among the first radial positions.

Note that the first data piece is the preamble PR, the sync mark SN, or the burst pattern (the burst pattern BP1 or the burst pattern BP2).

Since the temporal positions where the first data pieces are written are aligned at the first radial positions, suitable servo control can be performed. Specifically, for example, when the first data piece is the preamble PR, as described in the first embodiment, the calculation required for determining the timing for opening the servo gate signal is facilitated. For example, when the first data piece is the sync mark SN, as described in the second embodiment, it is possible to prevent unintended correction of the servo clock from being performed even when the rotation fluctuation following function is implemented. For example, when the first data piece is the burst pattern, as described in the third embodiment, the accuracy of the positioning control can be improved as compared with the comparative example.

According to the fourth embodiment, in the magnetic disk 11, a servo data piece (describe as a second data piece) whose type is different from that of the first data piece is written at a circumferential position (described as a second circumferential position different from the first circumferential position) where the temporal positions are aligned among the first radial positions.

In the example illustrated in FIG. 11, the first data piece is the preamble PR and the second data piece is the sync mark SN. The number of waveforms of one cycle included in the preamble PR, which is the first data piece, is different for each first radial position.

Thus, the calculation required for determining the timing for opening the servo gate signal SG is facilitated. Even when the rotational fluctuation following function is implemented, it is possible to prevent unintended correction of the servo clock from being performed.

Note that, as described in the fourth embodiment, the first data piece and the second data piece are not limited to the example described above.

According to the fifth embodiment, in the magnetic disk 11, the recording frequency of the servo data is different for each second radial position at continuous second radial positions different from the continuous first radial positions. In the specific configuration described in the fifth embodiment, for example, the continuous first radial positions is one of the regions 50a, 50b, and 50c and the continuous second radial positions is another one of the regions 50a, 50b, and 50c. In each of the servo regions SV, the first data piece is written at a circumferential position (described as third circumferential position) at the second radial positions where temporal positions are aligned among the second radial positions.

Note that, in the examples illustrated in FIGS. 13 and 14, the first data piece is the preamble PR or the sync mark SN. The first data piece may be the burst pattern.

According to the fifth embodiment, in the magnetic disk 11, in each of the servo regions SV, a servo data piece (described as third data piece) different from the first data piece is written at a circumferential position (described as fourth circumferential position) at the first radial positions where temporal positions are aligned among the first radial positions. The third data piece is written at a circumferential position (described as fifth circumferential position) at the second radial positions where the temporal positions are aligned among the second radial positions.

In the examples illustrated in FIGS. 15 and 16, the first data piece is the preamble PR and the third data piece is the sync mark SN. Note that the first data piece and the second data piece are not limited to these.

According to the example illustrated in FIG. 16, a temporal position corresponding to the fourth circumferential position, namely, a temporal position where the sync mark SN is written at the first radial positions is equal to a temporal position corresponding to the fifth circumferential position, namely, a temporal position where the sync mark SN is written at the second radial positions.

Thus, even while the magnetic head 22 is moving in a range in the radial direction including the first radial positions and the second radial positions, it is possible to detect the sync mark SN at the same interval as long as the rotation speed of the magnetic disk 11 does not fluctuate.

According to the sixth embodiment, in the magnetic disk 11, the recording frequency of the servo data is different for each first radial position at continuous radial positions (described as first radial positions). At continuous radial positions (described as second radial positions) located on the inner circumference side from the first radial positions, the recording frequency of the servo data is common at a certain value (described as first value). At continuous radial positions (described as third radial positions) located on the outer circumference side from the first radial positions, the recording frequency of the servo data is common at a certain value (described as second value).

In the example illustrated in FIG. 17, the region 60b corresponds to the first radial positions. When the region 60b is the first radial positions, the region 70a is the second radial positions and the region 70b is the third radial positions.

Thus, processing of acquiring a frequency to be set in the RWC 25 at the time of the sync search operation is facilitated. Thus, suitable servo control can be performed.

According to the sixth embodiment, the length of the range in the radial direction covering the second radial positions and the length of the range in the radial direction covering the third radial positions are equal to or larger than length obtained by multiplying an interval of time during which the magnetic head 22 passes over the servo region SV by maximum seek speed.

Thus, even when the magnetic head 22 is moving in the radial direction at high speed (for example, the maximum seek speed), it is possible to cause the magnetic head 22 to securely pass over the second radial positions or the third radial positions in the sync search operation.

Note that only one of the length of the range in the radial direction covering the second radial positions and the length of the range in the radial direction covering the third radial positions may be equal to or larger than the length obtained by multiplying the interval of the time during which the magnetic head 22 passes over the servo region SV by the maximum seek speed.

According to the sixth embodiment, the recording frequency of the servo data at the first value, namely, the second radial positions is equal to the recording frequency of the servo data at the second value, namely, the third radial positions.

Thus, the processing of acquiring the frequency to be set in the RWC 25 at the time of the sync search operation is facilitated.

Note that, in the above description, each of the first radial positions is the position of the track 41. Each of the first radial positions may be a representative position of two or more continuous tracks 41. The same applies to each of the second radial positions and each of the third radial positions.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk apparatus comprising:
a magnetic head; and
a magnetic disk on which servo regions are arranged in a circumferential direction at even intervals, each of the servo regions being a region in which servo data including data pieces is written, a recording frequency of the servo data being different between continuous first radial positions on the magnetic disk, a first data piece among the data pieces being written in each of the servo regions at a first circumferential position where movement times of the magnetic head in the circumferential direction are aligned among the first radial positions, the movement times being based on timing when the magnetic head passes over a reference position on a circumference of the magnetic disk.

2. The magnetic disk apparatus according to claim 1, wherein the first data piece is a preamble, a sync mark, or a burst pattern.

3. The magnetic disk apparatus according to claim 1, wherein, in each of the servo regions on the magnetic disk, a second data piece different from the first data piece among the data pieces is written at a second circumferential position where the movement times are aligned among the first radial positions, the second circumferential position being different from the first circumferential position.

4. The magnetic disk apparatus according to claim 3, wherein
the first data piece is a preamble,
the second data piece is a sync mark, and
the number of waveforms of one cycle included in the preamble written at the first circumferential position is differentiated among the first radial positions.

5. The magnetic disk apparatus according to claim 1, wherein, on the magnetic disk,
the recording frequency is different between continuous second radial positions different from the continuous first radial positions, and
the first data piece is written at a third circumferential position where the movement times are aligned among the second radial positions in each of the servo regions.

6. The magnetic disk apparatus according to claim 5, wherein the first data piece is a preamble or a sync mark.

7. The magnetic disk apparatus according to claim 5, wherein, in each of the servo regions on the magnetic disk,
a third data piece different from the first data piece among the data pieces is written at a fourth circumferential position where the movement times are aligned among the first radial positions, the fourth circumferential position being different from the first circumferential position, and
the third data piece is written at a fifth circumferential position where the movement times are aligned among the second radial positions, the fifth circumferential position being different from the third circumferential position.

8. The magnetic disk apparatus according to claim 7, wherein the first data piece is a preamble, and the third data piece is a sync mark.

9. The magnetic disk apparatus according to claim 8, wherein the movement time corresponding to the fourth circumferential position is equal to the movement time corresponding to the fifth circumferential position.

10. The magnetic disk apparatus according to claim 1, wherein
the magnetic disk includes concentric tracks provided on the magnetic disk, and
the first radial positions are radial positions on the concentric tracks.

11. A magnetic disk apparatus comprising:
a magnetic head; and
a magnetic disk on which servo regions are arranged in a circumferential direction at even intervals, each of the servo regions being a region in which servo data including data pieces is written, a recording frequency of the servo data being different between continuous first radial positions on the magnetic disk, the recording frequency being common at a first value among continuous second radial positions located on an inner circumference side from the first radial positions, the recording frequency being common at a second value among continuous third radial positions located on an outer circumference side from the first radial positions.

12. The magnetic disk apparatus according to claim 11, wherein length of a range in a radial direction covering the second radial positions or length of a range in the radial direction covering the third radial positions is equal to or larger than length obtained by multiplying an interval of time during which the magnetic head passes over the servo regions by a maximum seek speed.

13. The magnetic disk apparatus according to claim 11, wherein the first value and the second value are equal to each other.

14. The magnetic disk apparatus according to claim 11, wherein
the magnetic disk includes concentric tracks provided on the magnetic disk,
the first radial positions are radial positions of first tracks being some of the tracks,
the second radial positions are radial positions of second tracks located on an inner circumferential side from the radial positions of the first tracks among the tracks, and
the third radial positions are radial positions of third tracks located on an outer circumference side from the radial positions of the first tracks among the tracks.
